(19) United States
(12) Patent Application Publication
(10) Pub. No.: US 2004/0103151 A1
(43) Pub. Date: May 27, 2004

(54) System and method for sharing, viewing, and controlling multiple information systems

(75) Inventors: Guy Leighton Ettinger, Atlanta, GA (US); Adam Ford Redd, Marietta, GA (US); John Benjamin Atha, Kennesaw, GA (US)

Correspondence Address: KING & SPALDING LLP, 191 PEACHTREE STREET, N.E., ATLANTA, GA, 30303-1763, US

(73) Assignee: Applied Global Technologies, Inc., Rockledge, FL (US)

(21) Appl. No.: 10/690,345

(22) Filed: Oct. 21, 2003

Related U.S. Application Data
(60) Provisional application No. 60/419,983, filed on Oct. 21, 2002.

(51) Int. Cl. G06F 15/16

(52) U.S. Cl. 709/205

(57) ABSTRACT

A method and system for sharing information between a variety of telecommunication and computing resources. The system may employ client software modules to connect any combination of these resources to one another through a central server. The operation of the system may reduce the demand for bandwidth on a network as compared to other systems by distributing information from a resource only when that information changes.

### STATEMENT OF RELATED PATENT APPLICATIONS

This non-provisional patent application claims priority under 35 U.S.C. § 119 to U.S. Provisional Patent Application No. 60/419,983, titled System and Method for Sharing, Viewing, and Controlling Multiple Computer Systems, filed Oct. 21, 2002. This provisional application is hereby fully incorporated herein by reference.

### FIELD OF THE INVENTION

The present invention relates to a system and method for sharing, viewing, and controlling multiple information systems and more specifically to computer and telecommunication systems and computer implemented methods for sharing information between a wide variety of telecommunications and computer system components.

### BACKGROUND OF THE INVENTION

Advances in computer networking and high-speed communications have supported the almost instantaneous sharing of information. One example is videoconferencing, which enables groups of individuals at remote locations to see and hear each other and provide audio-visual presentation effects in real time across a computer network and telecommunication system.

Often, a goal of a videoconference is to allow remote parties to collaborate. This collaboration may include working together on a drawing set, editing a word processor document, or manipulating a spreadsheet. Computer software running on desktop computers over a network has been developed that enhances the capability of individuals to collaborate with remote groups. This software includes providing “white boards” for participants to use, where everyone can see the board, to desktop sharing, where one participant can let other participants see her desktop. An example of a program that enables desktop sharing is the open-source program VNC.

Another application of information sharing is monitoring remote computer desktops. This monitoring may support network maintenance, such as troubleshooting a problem at a specific machine or monitoring the status of a number of machines. Alternatively, this monitoring may facilitate computer-based instruction, as where a teacher can monitor activities taking place on a student's desktop. Software currently exists to support these monitoring activities.

Despite these advances in desktop sharing computer software, the amount of information that can be passed over networks containing the desktop computers is finite. Bandwidth, the information-carrying capacity of the telecommunications links between the computer networks, is a valuable resource. Many of the desktop sharing tools tax the bandwidth capability between network systems. The large bandwidth use is attributable to one desktop sending a full-size image across the network to a second desktop, which may or may not resize that image. A constant challenge to telecommunications between computer systems is to limit the drain on the bandwidth resource.

Another limitation is the telecommunication resources that can participate in a collaboration. Large-scale videoconferencing allows participants in remote locations to attend meetings as if they are at a single table, by providing video and audio links between the locations. These videoconferences may be connected over dedicated communication lines or over a distributed network, such as the internet. To connect videoconference calls between parties (endpoints) on different networks, the networks must have specialized equipment. This equipment includes codecs, multipoint control units (MCUs), gateways, gatekeepers, multipoint-capable endpoints, and desktop computers with direct connections to ISDN or other telecommunications lines. A codec, or coder-decoder is the core (or “engine”) of a video conference system and is responsible for all of the encoding and decoding of information (audio and video). Before the transmission, the codec converts analog signals to digital signals and compresses the digital signals. Incoming audio and video must be decompressed and converted from digital back to analog.

MCUs, which are made up of both hardware and software components, are needed to support teleconferences with more than four participants and are an expensive resource for a network. MCUs have multiple ports to manage the call flow-control and processes and to distribute the audio, video, and data streams to the videoconference participants. Networks can have multiple MCUs. Gateways, which can be hardware and/or software, connect network endpoints to endpoints outside the network over ISDN or other telecommunications lines. Gatekeepers are software programs that manage bandwidth within a network zone. LANs may be divided up into zones. A gatekeeper manages bandwidth use for a particular network zone and determines if connections between zones have sufficient bandwidth to carry a videoconference call. Multipoint-capable endpoints are essentially mini MCUs and can videoconference with three other endpoints without using an MCU. Finally, an endpoint, such as a desktop computer on the LAN, can have a direct connection to an ISDN or other telecommunications line. If this endpoint needs to connect to a videoconference involving others outside that endpoint's network zone, the call can be initiated without using an MCU. Although a desktop computer can participate in this type of large-scale video conference, this participation is typically limited to audio and video over a peripheral camera or displaying a presentation to other participants, such as by using a software program such as POWERPOINT, by the Microsoft Corporation, Redmond, Wash.

The prior art includes client-to-client desktop sharing applications. This architecture, coupled with the inability of the desktop source to adjust the size of its desktop to a variety of sizes before the desktop image is sent, fails to address the demand for bandwidth that accompanies these desktop sharing programs. The applications constantly poll the desktop for the other computers, constantly using bandwidth resources.

What is needed is a source-to-server-to-client computer-implemented method and system that enables the functionality of information sharing, yet limits the amount of bandwidth required to implement that functionality. This need includes the capability of sharing information within a common system between large-scale videoconferencing resources, personal computers, and other telecommunication resources.

### SUMMARY OF THE INVENTION

The present invention provides a computer implemented method and system for sharing information between telecommunication resources. These resources may include desktop computers, codecs, network workstations, and other telecommunication resources, such as a telephone.

One aspect of the present invention provides a system that includes one or more telecommunications or computing resources, each having an adapter module operable to translate one or more data items from the one of the resources and to distribute the translated data items in response to a change in one or more of the data items. The system also includes a system server module, operable to received translated data items from an adapter module and further operable to process the data items. Upon processing, the system server module distributes the processed data items to one or more of the resources.

In another aspect of the present invention a method for sharing information is provided, which includes the steps of (1) capturing a data instance from a telecommunications or computing system resource; (2) translating the data; (3) sending the translated data to a system server module; (4) capturing a second data instance; (5) if the second data instance is different from the first input data instance, than translating the second data instance; and (6) if the second data instance is different from the first input data instance, sending the translated second data instance to the system server module.

In another aspect of the present invention, a method for sharing data between a videoconferencing system and a personal computer is provided, which includes the steps of (1) capturing a data instance from the videoconferencing system; (2) translating the data instance; (3) sending the translated data instance to a system server module; (4) processing the data instance into an output data instance by the system server module; (5) distributing the output data instance to an adapter module associated with the personal computer; (6) translating the output data instance; and (7) presenting the output data instance by the personal computer.

Another aspect of the present invention provides a method similar to the method above but involving sharing information among one or more personal computers.

The aspects of the present invention may be more clearly understood and appreciated from a review of the following detailed description of the disclosed embodiments and by reference to the drawings and claims.

### BRIEF DESCRIPTION OF THE DRAWINGS

FIG. 1 provides a network diagram illustrating a representative operating environment for an exemplary embodiment of the present invention.

FIG. 2 provides a block diagram illustrating representative functional components for an exemplary embodiment of the present invention.

FIG. 3 provides a flow diagram presenting a process for sharing information between telecommunication and computer resources in accordance with an exemplary embodiment of the present invention.

FIG. 4 provides a flow diagram presenting a process for establishing a meeting involving telecommunication resources in accordance with an exemplary embodiment of the present invention.

FIG. 5 provides a flow diagram presenting a process for sharing information between a personal computer resource and other telecommunications resources in accordance with an exemplary embodiment of the present invention.

FIG. 6 provides a flow diagram presenting a process for sharing information between a videoconferencing resource and other telecommunications resources in accordance with an exemplary embodiment of the present invention.

FIG. 7 provides a flow diagram presenting a process for sharing information between a telephone resource and other telecommunications resources in accordance with an exemplary embodiment of the present invention.

FIG. 8 provides a block diagram illustrating personal computers sharing display screens in accordance with an exemplary embodiment of the present invention.

FIG. 9a depicts bandwidth performance of an exemplary embodiment of the present invention.

FIG. 9b also depicts bandwidth performance of an exemplary embodiment of the present invention.

FIG. 9c also depicts bandwidth performance of an exemplary embodiment of the present invention.

FIG. 9d also depicts bandwidth performance of an exemplary embodiment of the present invention.

FIG. 10 presents a display image illustrating a desktop computer window used to conduct information sharing in accordance with an exemplary embodiment of the present invention.

FIG. 11 presents a display image illustrating a shared computer desktop in accordance with an exemplary embodiment of the present invention.

FIG. 12 presents a display image illustrating a shared computer desktop of a single meeting participant in accordance with an exemplary embodiment of the present invention.

FIG. 13 presents a display image illustrating a shared computer desktop of a single meeting participant that has been updated in response to a change at the image source in accordance with an exemplary embodiment of the present invention.

FIG. 14 presents a display image illustrating multiple shared computer desktops in accordance with an exemplary embodiment of the present invention.

FIG. 15 presents a display image illustrating a shared computer desktop of one of participants of a meeting in accordance with an exemplary embodiment of the present invention.

FIG. 16 presents a display image illustrating a shared computer desktop of one of participants of a meeting that has been detached from a window presenting the meeting in accordance with an exemplary embodiment of the present invention.

FIG. 17 presents a display image illustrating sharing computer desktops from multiple meeting resources, with each screen displayed at 160 pixels by 120 pixels, in accordance with an exemplary embodiment of the present invention.

FIG. 18 presents a display image illustrating sharing computer desktops from multiple meeting resources, with each screen displayed at 320 pixels by 240 pixels, in accordance with an exemplary embodiment of the present invention.

FIG. 19 presents a display image illustrating sharing computer desktops and video images from multiple meeting resources, with each screen displayed at 320 pixels by 240 pixels, in accordance with an exemplary embodiment of the present invention.

FIG. 20 presents a display image illustrating sharing computer desktops and video images from multiple meeting resources, with each screen displayed at 160 pixels by 120 pixels, in accordance with an exemplary embodiment of the present invention.

### DETAILED DESCRIPTION OF EXEMPLARY EMBODIMENTS

Exemplary embodiments of the present invention provide a system and computer-implemented method for sharing information between multiple and varied telecommunications resources, while limiting the use of computer network bandwidth.

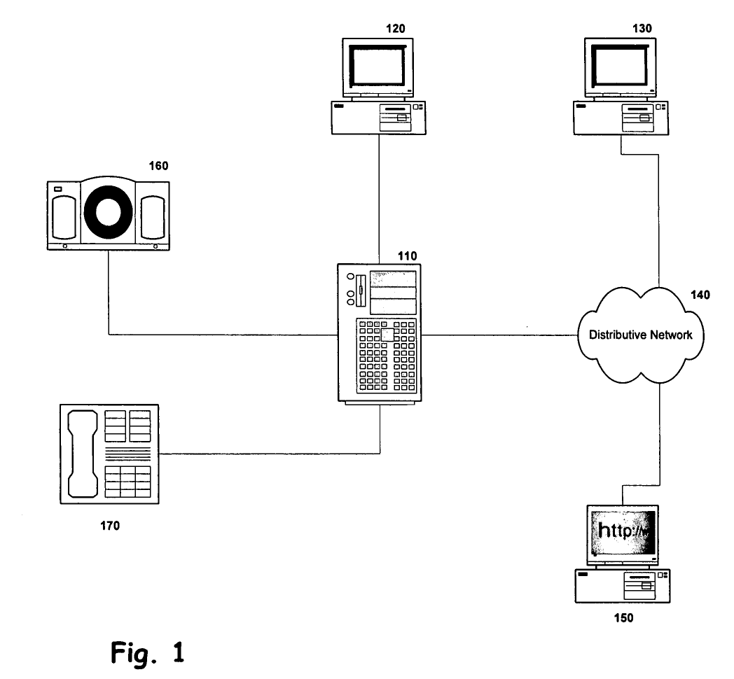

FIG. 1 provides a network diagram illustrating a representative operating environment 100 for an exemplary embodiment of the present invention. Referring to FIG. 1, this operating environment 100 includes a personal computer 120 connected to a system server 110. The operating environment also includes a workstation 130. This workstation 130 is connected to a distributed network 140. The distributed network 140 may be a LAN or wide-area-network (WAN), such as the internet. The workstation 130 may be a personal computer or computer terminal. Also connected to the distributed network 140 is a personal computer 150. The personal computer 150 is capable of running a software application, such as a web browser, for translating information provided in hypertext markup language (HTML). The distributed network 140 is connected to the server 110 by a dedicated or other telecommunications line, such as a T1, ISDN, DSL, or other line. Alternatively, this connection may be through a wireless communications network.

The operating system 100 also includes a videoconferencing system 160, which may include a codec, which may link to the system server 110 through an MCU. The operating environment 100 also includes a telephone 170.

One skilled in the art would appreciate that alternative operating environments could be used. For example, the operating environment can include components on a common LAN. Alternatively, the distribution network 140 could be multiple, independent distributed networks, with different components connected to the system server 110 through different distributed networks. Also, an alternative operating environment may not have all of the types of telecommunication components illustrated in the operating environment 100 and this alternative operating environment may have multiple occurrences of a single component type. Also, an alternative operating environment may include telecommunication components not contained in the operating environment 100, such as a portable digital assistant (PDA) or videophone.

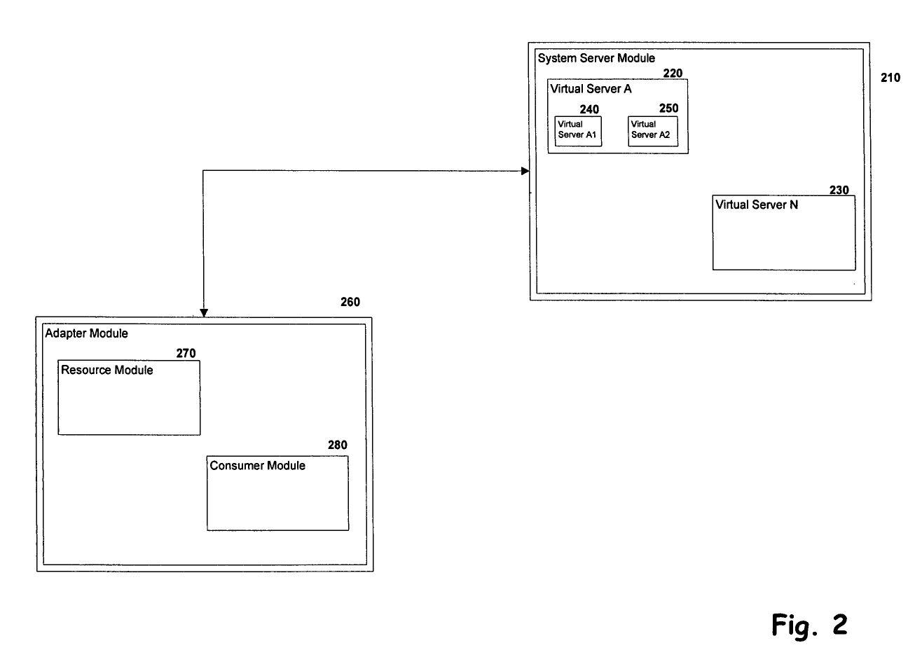

FIG. 2 provides a block diagram 200 illustrating representative functional components for an exemplary embodiment of the present invention. Referring to FIGS. 1 and 2, in this exemplary embodiment, computer software modules include a system server module 210 and an adapter module 260. The system server module 210 may include a number of virtual servers, such as virtual server A 220 up to virtual server N 230. The system server module 210 instantiates a single virtual server to correspond to a single meeting. This virtual server exists for as long as the corresponding meeting exists. Once the meeting ends, the system server module 210 extinguishes the corresponding virtual server. The system server module 210 may instantiate any number of virtual servers to facilitate information sharing.

A meeting is defined as a sharing of information between two or more resources. These resources may include personal computers, videoconferencing equipment, or other telecommunication equipment and the meeting may involve resources of a single type or of varying type. For example, if two personal computers want to share information, such as by collaborating on a document contained on one of the personal computers, the system server module 210 would instantiate a virtual server that corresponds to that collaboration, or meeting.

Each virtual server corresponding to a meeting, such as virtual server A 220 or virtual server N 230, may include addition virtual servers, such as virtual server A1 240 and virtual server A2 250, which are associated with virtual server A 220. These additional virtual servers 240, 250 are instantiated by the system server 210 to handle specific tasks within a meeting. These tasks may include gathering information from or distributing information to a specific resource. When a specific task within a meeting is no longer needed, the virtual server instantiated for that task is extinguished, such as when a specific resource disconnects from a meeting. One skilled in the art would appreciate that software module configurations, other than virtual servers, could be developed to perform the methods described here.

The adapter module 260 is associated with a client, or resource. The adapter module 260 may reside on a resource, such as the personal computer 120. Alternatively, the adapter module 260 could reside on an intermediate system component, such as a component on the distributed network 140, like a web server, or an MCU. Also, the adapter module 260 could reside on the system server 110.

The adapter module 260 includes a resource module 270 and a consumer module 280. The resource module 270 is associated with tasks that deliver information from a client to the system server 110. For example, the resource module 270 translates the desktop image of the personal computer 120 and distributes that image to the system server module 210 resident on the system server 110. The consumer module 280 is associated with tasks that deliver information to the client. For example, the consumer module 280 may receive information corresponding to an audio and video stream from the videoconferencing system 160 from the system server module 210 and translate that information into input that can be presented on a display device of the personal computer 120. One skilled in the art would appreciate that the resource module 270 and consumer module 280 may include a variety of object-based programs that perform specific tasks within the overall function of the module and that the delineation between modules could be different.

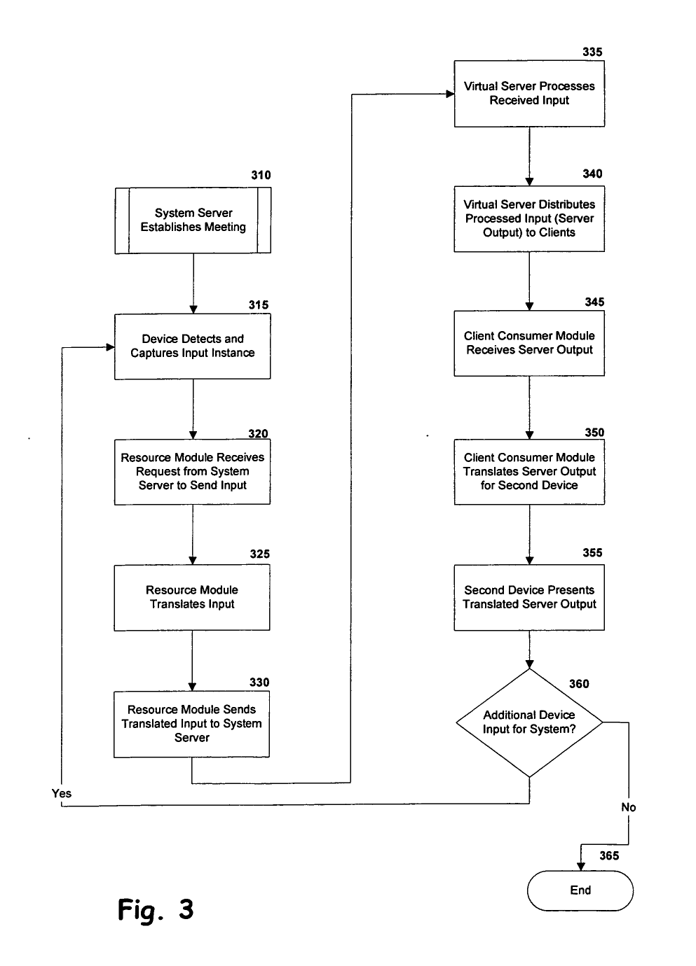

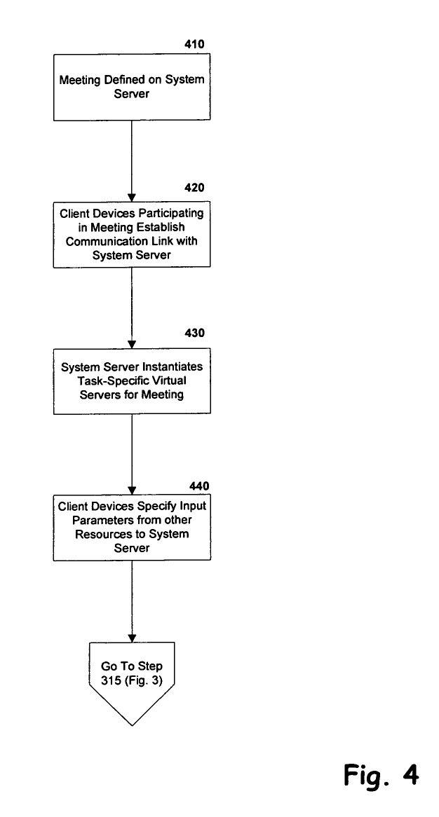

FIG. 3 provides a flow diagram presenting a process 300 for sharing information between telecommunication and computer resources in accordance with an exemplary embodiment of the present invention. Referring to FIGS. 1, 2, and 3, at step 310, the system server 110, through the system server module 210, establishes a meeting including two or more resources, also referred to herein as clients, devices, or components. This step is discussed in greater detail below, in connection with FIG. 4.

At step 315, a resource detects and captures an input instance. In this step, a resource detects and captures input independent of the resource's participation in a meeting. For example, a videoconferencing system 160 may capture audio and video from a group of people in front of a camera that is part of the videoconferencing system 160. The audio and video information is coded by a codec component. In another example, a video card in a personal computer 120 may capture an image that corresponds to the desktop image of the personal computer 120.

At step 320, the resource module 270 of the adapter module 260 that is associated with the resource involved in step 315 receives a request from the system server module 210 to send information. In response to this request, at step 325, the resource module 270 translates the input instance captured at step 315. Some resources, such as the telephone 170, are not responsive to requests from the system server module 210. For these resources, the step 320 is skipped and the resource module 270 translates information periodically or as necessary.

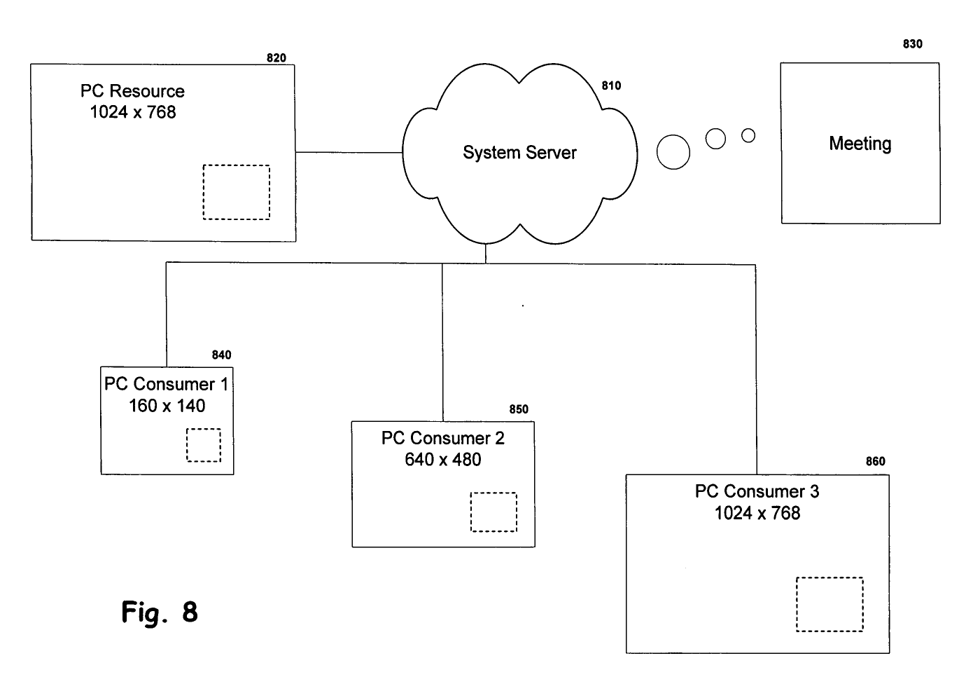

At step 325, the resource module 270 translates the captured data into a form that can be transferred to the system server module 210. For an image, such as the image of a desktop, this step 325 includes translating the image to a size equal to the greatest requested size less than or equal to the actual size of the image. The requested size may be specified at step 310 or received at step 320. For example, a desktop image may be 1024 by 768 pixels in size. Other meeting participants may request the image at a size of 160 pixels by 140 pixels or 640 pixels by 480 pixels. The image would be translated to the maximum size request, or the actual size of the image, if smaller. This process is discussed in greater detail below, in conjunction with FIG. 8.

At step 330, the resource module 270 sends the translated input to the system server module 210. At step 335, a virtual server, such as virtual server A 220, that was instantiated by the system server module 210 and that corresponds to the specific task of managing the input from the resource processes the received input. At this step, the information may be formatted to satisfy parameters specified by other resources involved in the meeting. At step 340, the virtual server distributes the processed information to the client adapter modules for other meeting participants that can or want to receive the information. For example, other personal computers, video conferencing equipment, or a videophone may receive a desktop image from a resource, while a regular telephone may not receive that image.

At step 345, a client consumer module 280 for one of the resources that are receiving the information distributed at step 340 receives the information. At step 350, the consumer module 280 translates the information for the client device. For example, this step may include translating the information to be received by a video card in a personal computer so that the information can be displayed on a computer monitor associated with that personal computer. At step 355, the resource presents the translated data.

At step 360, the process 300 determines if the device from step 315 has additional information for the meeting. Typically, a device will continually provide information throughout a meeting as long as the device is participating in the meeting. Once the device drops off a meeting, the process 300, at step 360, would move to step 365 and terminate the process. The entire process has been presented as a series of steps. One skilled in the art would appreciate that some steps may occur in parallel. For example, while the system server module 210 processes and distributes information, individual resources may be capturing, translating, and distributing new information to the system server module 210.

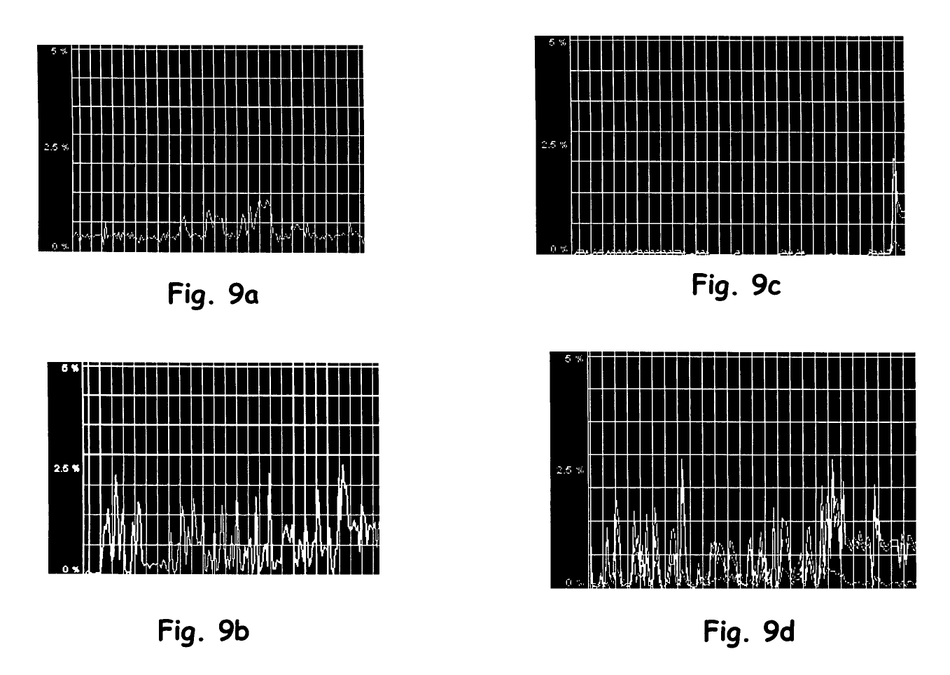

Although a device, or resource, participating in a meeting will typically continually deliver information to a meeting, if a certain information type has not changed, then that information will not be sent. For example, if the image of a desktop has remained the same, that image will not be constantly sent by the resource module 270 to the system server module 210. Instead, the image will be sent only after it changes. This feature limits the use of valuable bandwidth, by sending images only when they have changed, rather then at some constant rate. This beneficial bandwidth performance is discussed in greater detail below, in connection with FIG. 9. One skilled in the art will appreciate that not all resources can take advantage of this feature. For example, a video camera continually captures frames of data and may not be capable of determining if the image has changed or may be in a dynamic environment, such as a room with people, where the image changes from frame to frame. In this case, the information is updated as requested at a periodic rate.

FIG. 4 provides a flow diagram presenting a process 310 for establishing a meeting involving telecommunication resources in accordance with an exemplary embodiment of the present invention. Referring to FIGS. 1, 2, 3, and 4, at step 410, a meeting is defined on the system server module 210 that resides on the system server 110. The meeting may be defined by actions from one or more client resources through an adapter module 260. For example, a user may indicate, through a personal computer 120 with an adapter module 260 resident on the personal computer 120, one or more resources that will participate in a meeting. This indication may specify the participants and the type of resource for each participant. One user or multiple users may provide this indication to the system server module 210. Alternatively, a meeting may be initiated on an ad hoc basis. In this alternative, each resource may contact the system server module 210 to participate in a meeting at that time.

At step 420, at the time of the meeting, a communication link is established between the system server 110 and the resources that will participate in the meeting. This communication link could be initiated by a resource, such as by entering a universal resource locator (URL) address into a browser or by dialing into a network, or by the system server 110.

At step 430, in response to establishing a communications link between a resource and the system server 110, the system server module 210 instantiates one or more task-specific virtual servers for conducting the meeting. At step 440, the resources specify input parameters that they require from other meeting participant resources. For example, an adapter module 260 resident on the personal computer 120 may specify the size of the images from other participants that the user requires and what input that adapter module 260 will provide, such as desktop images, chat capability, and audio/video from a peripheral device attached to the personal computer 120. A virtual server associated with the meeting and associated with supplying information to a specific consumer module 280 will maintain information on the requested information parameters of that specific resource, such as the requested image size.

Although these request parameters are provided at the establishment phase of a meeting, they may be changed throughout the course of the meeting. The system server module 210 is responsive to updates to the required input parameters specified by each meeting participant. Following this step, the process 310 moves to step 315 of process 300.

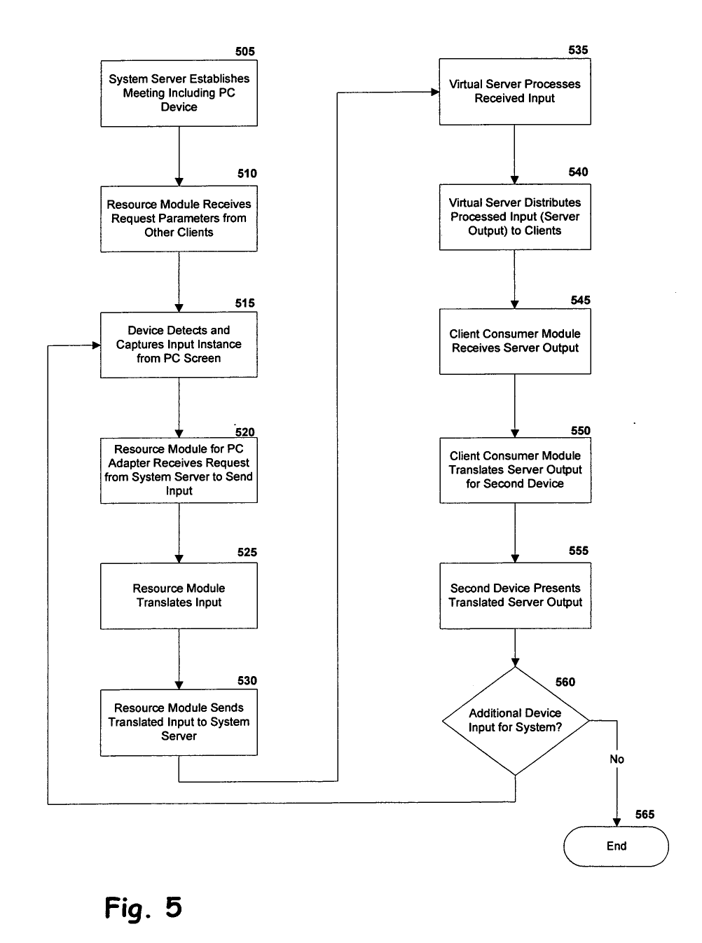

FIG. 5 provides a flow diagram presenting a process 500 for sharing information between a personal computer resource and other telecommunications resources in accordance with an exemplary embodiment of the present invention. This process 500 provides a specific implementation of process 300 involving a personal computer 120. Referring to FIGS. 1, 2, 3, 4, and 5, at step 505, the system server 110, through the system server module 210, establishes a meeting including two or more resources, including at least one personal computer 120. This step is discussed in greater detail above, in connection with FIG. 4. At step 510, a resource module 270 resident on the personal computer 120 receives a set of request parameters. These parameters may be initially established at step 440 of process 310. These parameters may specify the types and quality of information to be supplied to the system server module 210 from the adapter module 260 resident on the personal computer 120.

At step 515, a component of the personal computer 120 detects and captures an input instance. For example, a video card in the personal computer 120 may capture an image that corresponds to the desktop image of the personal computer 120. In another example, a software application capable of conducting chats, or real-time messaging, may detect that text has been entered into a data entry user interface that corresponds to the chat capability.

At step 520, the resource module 270 of the adapter module 260 resident on the personal computer 120 receives a request from the system server module 210 to send information. In response to this request, at step 525, the resource module 270 translates the input instance captured at step 515. Some input instances from step 515 may be sent by the resource module 270 to the system server module 210 without receiving a request. For example, a chat message may be sent from the resource module to the system server module 210 as soon as the message is captured. For these input instances, the step 520 is skipped.

For an image, such as the image of a desktop, this step 525 includes translating the image to a size equal to the greatest requested size less than or equal to the actual size of the image. The requested size parameter may be received at step 510 or received at 520, such as when a resource participating in the meeting has modified its required input parameters. For example, a desktop image may be 1024 by 768 pixels in size. Other meeting participants may request the image at a size of 160 pixels by 140 pixels or 640 pixels by 480 pixels. The image would be translated to the maximum size request, or the actual size of the image, if smaller. This process is discussed in greater detail below, in conjunction with FIG. 8.

At step 530, the resource module 270 sends the translated input to the system server module 210. At step 535, a virtual server, such as virtual server A 220, that was instantiated by the system server module 210 in process 310 and that corresponds to the specific task of managing the input from the personal computer 120, processes the received input. At this step, the image may be formatted to satisfy parameters specified by other resources involved in the meeting. For example, a desktop image may be resized to meet the requirements of a specific resource that will consume the desktop during the meeting. At step 540, the virtual server distributes the processed information to the client adapter modules for other meeting participants that can or want to receive the information from the personal computer 120. For example, other personal computers or video conferencing equipment may receive a desktop image from the personal computer 120, while a telephone may not receive that image.

At step 545, a client consumer module 280 for one of the resources that are receiving the information distributed at step 540 receives the information. At step 550, the consumer module 280 translates the information for the client device. For example, this step may include translating the information to be received by a video card in a second personal computer, such as personal computer 150, which may be connected to the meeting through a web browser, so that the information can be displayed on a computer monitor associated with that personal computer 150. At step 555, the resource presents the translated data.

At step 560, the process 500 determines if the personal computer 120 has additional information for the meeting. Typically, a device will continually provide information throughout a meeting as long as the device is participating in the meeting. As such, the process will continually loop back to step 515 as long as the personal computer 120 is participating in the meeting. Once the personal computer 120 drops off the meeting, the process 500, at step 560, would move to step 565 and terminate the process as to the personal computer 120. The meeting may continue with other participants. The entire process has been presented as a series of steps. One skilled in the art would appreciate that some steps may occur in parallel. For example, while the system server module 210 processes and distributes information, individual resources may be capturing, translating, and distributing new information to the system server module 210.

Although a device, or resource, participating in a meeting will typically continually deliver information to a meeting, if a certain information type has not changed, then that information will not be sent. For example, if the image of a desktop on the personal computer 120 has remained the same, that image will not be constantly sent by the resource module 270 to the system server module 210. Instead, the image will be sent only after it changes. This feature limits the use of valuable bandwidth, by sending images only when they have changed, rather then at some constant rate. This beneficial bandwidth performance is discussed in greater detail below, in connection with FIG. 9.

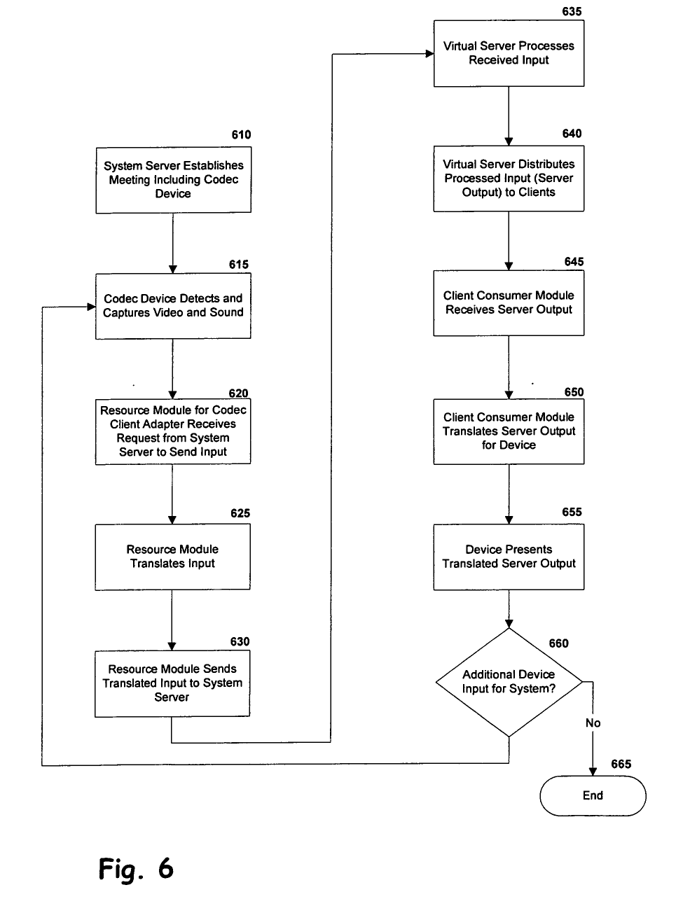

FIG. 6 provides a flow diagram presenting a process 600 for sharing information between a videoconferencing resource and other telecommunications resources in accordance with an exemplary embodiment of the present invention. Referring to FIGS. 1, 2, 3, and 6, at step 610, the system server 110, through the system server module 210, establishes a meeting including two or more resources, where at least one of those resources is a videoconferencing system 160. This step is discussed, in general terms, in greater detail above, in connection with FIG. 4.

At step 615, a codec device detects and captures an input instance. In this step, a resource detects and captures input independent of the resource's participation in a meeting. For example, the videoconferencing system 160 may capture audio and video from a group of people in front of a camera that is part of the videoconferencing system 160. The audio and video information is coded by the codec component.

At step 620, the resource module 270 of the adapter module 260 that is associated with the videoconferencing system 160 receives a request from the system server module 210 to send information. This resource module 270 may reside on a PC-based server that a videoconferencing endpoint can contact, the codec, the MCU, or other videoconferencing device for the videoconferencing system 160 capable of running the software module.

In response to this request, at step 625, the resource module 270 translates the input instance captured at step 615. The videoconferencing system 160 is continuously capturing audio and video input at a location. However, this information may be sent to the system server module at a frequency that is less than this capture frequency. As such, this less frequent request rate may result in a fraction of the captured frames sent to the system server module 210.

For a video image from the videoconferencing system 160, this step 625 may include translating the image to a size equal to the greatest requested size less than or equal to the actual size of the image. The requested size may be specified at step 610 or received at step 620. Alternatively, the image may be sent to the system server module 210, which then resizes the image.

At step 630, the resource module 270 sends the translated input to the system server module 210. At step 635, a virtual server, such as virtual server A 220, that was instantiated by the system server module 210 and that corresponds to the specific task of managing the input from the videoconferencing system 160 processes the received input. At this step, the image may be formatted to satisfy parameters specified by other resources involved in the meeting. At step 640, the virtual server distributes the processed information to the client adapter modules for other meeting participants that can or want to receive the information. For example, personal computers or other video conferencing equipment may receive an image from the videoconferencing system 160, while a telephone may not receive that image.

At step 645, a client consumer module 280 for one of the resources that are receiving the information distributed at step 640 receives the information. At step 650, the consumer module 280 translates the information for the client device. For example, this step may include translating the information to be received by a video card in a personal computer so that the video image from the videoconferencing system 160 can be displayed on a computer monitor associated with that personal computer and the audio component can be played through a sound card in the personal computer. At step 655, the resource presents the translated data.

At step 660, the process 600 determines if the videoconferencing system 160 has additional information for the meeting. Typically, the videoconferencing system 160 will continually provide information throughout a meeting as long as the device is participating in the meeting. Once the videoconferencing system 160 drops off the meeting, the process 600, at step 660, would move to step 665 and terminate the process as to the videoconferencing system 160. The entire process has been presented as a series of steps. One skilled in the art would appreciate that some steps may occur in parallel. For example, while the system server module 210 processes and distributes information, individual resources may be capturing, translating, and distributing new information to the system server module 210.

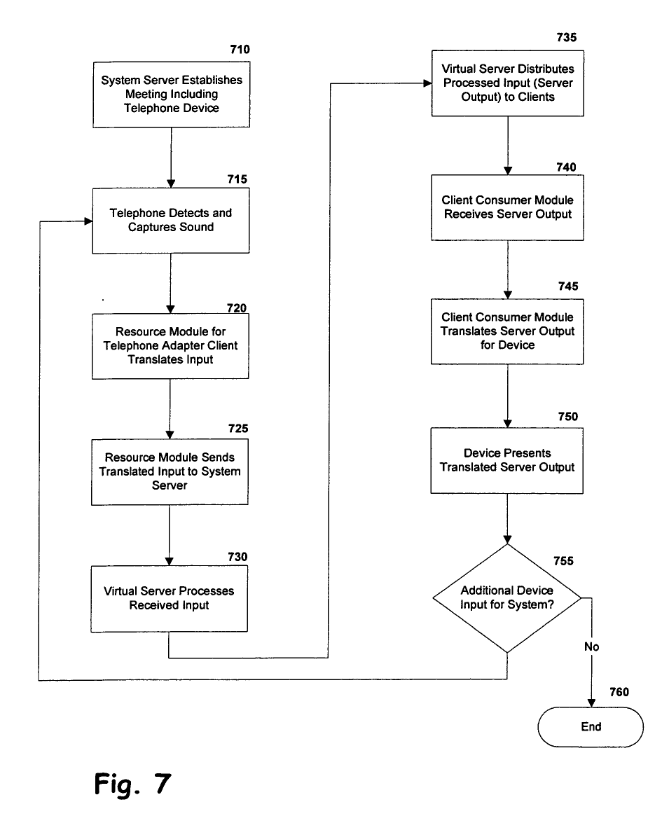

FIG. 7 provides a flow diagram presenting a process 700 for sharing information between a telephone resource and other telecommunications resources in accordance with an exemplary embodiment of the present invention. Referring to FIGS. 1, 2, 3, and 7, at step 710, the system server 110, through the system server module 210, establishes a meeting including two or more resources, where at least one of those resources is a telephone 170. The telephone 170 may be a land line, a cellular phone, or a telephony device. The meeting may be established by the telephone 170 calling into designated server.

At step 715, the telephone 170 detects and captures an input instance, such as when a user talks into the telephone. At step 720, the resource module 270 translates the input instance captured at step 715. For a telephone resource, the adapter module 260 and associated modules, such as the resource module 270, may reside on an intermediate component, such as a server that is connected to the system server 110 and that can be called from the telephone, or the adapter module 260 may reside on the system server 110.

At step 725, the resource module 270 sends the translated input to the system server module 210. The nature of the telephone is such that whenever an input instance is detected, the resource module 270 translates and sends the input almost immediately. At step 730, a virtual server, such as virtual server A 220, that was instantiated by the system server module 210 and that corresponds to the specific task of managing the input from the telephone 170 processes the received input. At step 735, the virtual server distributes the processed information to the client adapter modules for other meeting participants that can or want to receive the information.

At step 740, a client consumer module 280 for one of the resources that are receiving the information distributed at step 735 receives the information. At step 745, the consumer module 280 translates the information for the client device. For example, this step may include translating the information to be played through a sound card in the personal computer. At step 750, the resource presents the translated data.

At step 755, the process 700 determines if the telephone 170 has additional information for the meeting. Typically, a telephone 170 will provide information sporadically throughout the meeting. Once the telephone 170 drops off the meeting, the process 700, at step 755, would move to step 760 and terminate the process as to the telephone 170. The entire process has been presented as a series of steps. One skilled in the art would appreciate that some steps may occur in parallel. For example, while the system server module 210 processes and distributes information, individual resources may be capturing, translating, and distributing new information to the system server module 210.

FIGS. 5, 6, and 7 present specific examples of exemplary processes for specific telecommunication components. One skilled in the art would appreciate that other components, such as a PDA connected to a wireless network or a videophone, could be employed in the present invention. Similarly, the processes 500, 600, and 700 are directed to a meeting from the point of view of a single meeting component. One skilled in the art would appreciate that these processes may occur simultaneously for any number of resources that are connected to a meeting and that a single system server 110 could host multiple meetings simultaneously.

FIG. 8 provides a block diagram 800 illustrating personal computers sharing display screens in accordance with an exemplary embodiment of the present invention. The capability of the present invention for providing only the desired resolution of certain types of information during a meeting minimizes the bandwidth used during the meeting. Exemplary embodiments of the present invention rely on a dynamic resource-server-client structure for information sharing. The structure is referred to as dynamic because many information types from a resource can be dynamically resized for optimal transportation across a network. In the example of FIG. 8, a resource computer chooses a maximum viewing size for its shared desktop less than or equal to the computer's actual desktop size, known as the maximum source viewing size. Likewise, each client determines the size of the desktop view by picking a viewing size less than or equal to the maximum source viewing size, known as the client requested viewing size. The source desktop then sends updates proportional to the largest client requested viewing size to the server. The server then dynamically generates a resized version of these desktop updates for each of the requested client sizes and sends the appropriate resized desktop updates to each client.

Referring to FIGS. 2 and 8, a desktop resource 820 sends the source, a desktop image, at 1024 pixels by 768 pixels, using necessary bandwidth to send this high resolution image to all three clients 840, 850, and 860. With the source-server-client configuration, the high resolution image requested by desktop 860 is sent once from the desktop source 820 to system server 210. Lower resolution images are then sent to desktop client 840 and 850, reducing the bandwidth use of the network, while the full image is sent to desktop 860.

An additional feature of this exemplary embodiment of the present invention is that updated images are sent to the client desktops 840, 850, and 860 only when the image changes at the desktop source 820, rather than periodically as with the prior art. This feature again limits the use of bandwidth, by sending images only when necessary.

FIGS. 9a-9d depict bandwidth performance of an exemplary embodiment of the present invention, from a four-computer trial on a medium sized 100 Mbps corporate LAN with normal traffic. Two machines are source desktops at 1024×768 at 32 bit color depth with image compression enabled. One machine is acting as the Desktop Server. The final machine is viewing both served desktops as a desktop client. For these tests, low activity is defined as a machine without user input and high activity is defined as a machine with high user input (maximizing windows, moving windows, interacting with the start bar, etc). In all results, clients peaked at less than 4 percent of the 100 Mbps bandwidth. Theoretically, in situations with lower bandwidth, the network timed loop should adapt the flow of screen updates for less traffic.

FIG. 9a shows the percentage of bandwidth use with a desktop client viewing two highly active desktops at a 160 pixels by 120 pixels resolution. FIG. 9b shows the bandwidth use viewing a highly active 1024 pixels by 768 pixels desktop. FIG. 9c shows the bandwidth use from a desktop server client at a 1024 pixels by 768 pixels resolution with no activity. The small peaks are caused by taskbar updates and the large peak is caused by opening the capture window. FIG. 9d shows a desktop server with high activity at 1024 pixels by 768 pixels resolution.

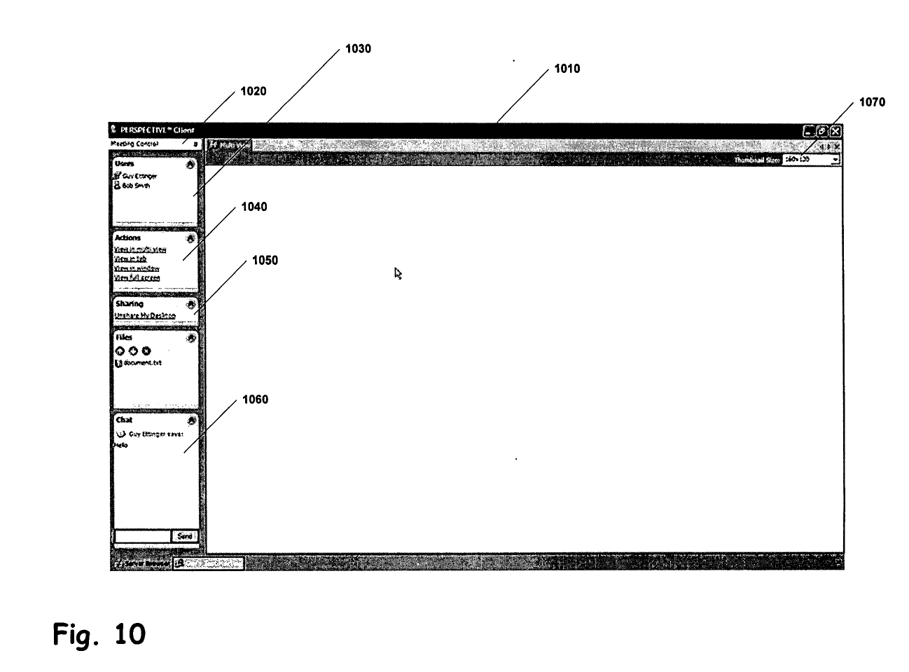

FIGS. 10-20 provide display images that may be seen by a user in accordance with an exemplary embodiment of the present invention. These display images are used to illustrate functions described above, in conjunctions with FIGS. 3-7.

FIG. 10 presents a display image 1000 illustrating a desktop computer window used to conduct information sharing in accordance with an exemplary embodiment of the present invention. Referring to FIGS. 2 and 10, a window 1010 generated by an adapter module 260 is shown. The window 1010 provides a series of meeting controls 1020. These controls include actions 1040, sharing specifications 1050, and a chat capability 1060. The window 1010 also provides a control 1070 that enables a user to select the resolution for display images to be presented within the window 1010. These display images are provided by other meeting participants and are supplied, at the requested sized, by the system server module 210.

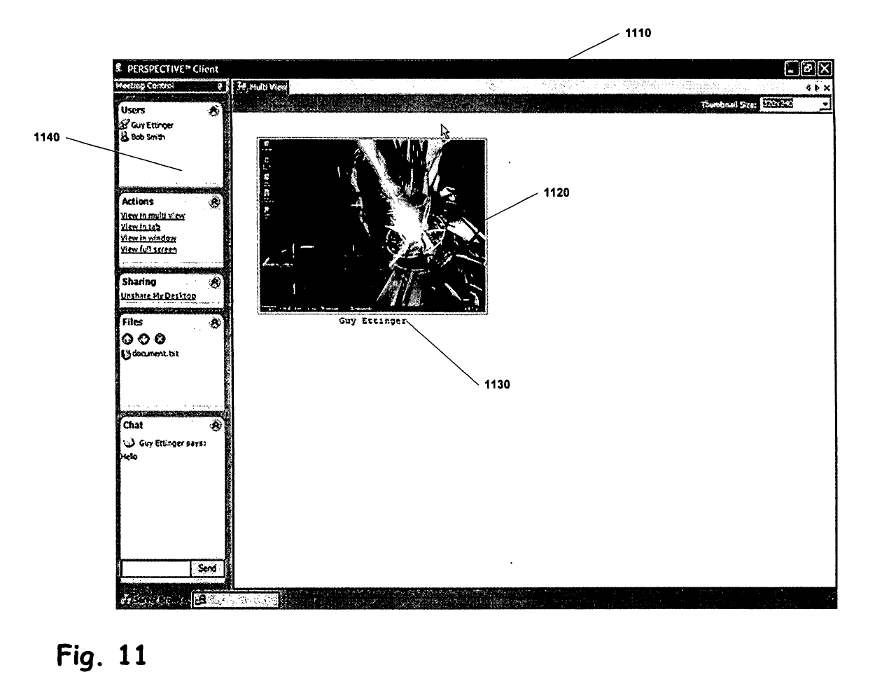

FIG. 11 presents a display image 1100 illustrating a shared computer desktop in accordance with an exemplary embodiment of the present invention. Referring to FIG. 11, window 1110 presents a desktop image 1120 of a meeting participant. This image may be labeled with the name of the user whose desktop is displayed, such as a label “Guy Ettinger” 1130. The meeting participants, or users, may be listed in a section 1140 of the window 1110.

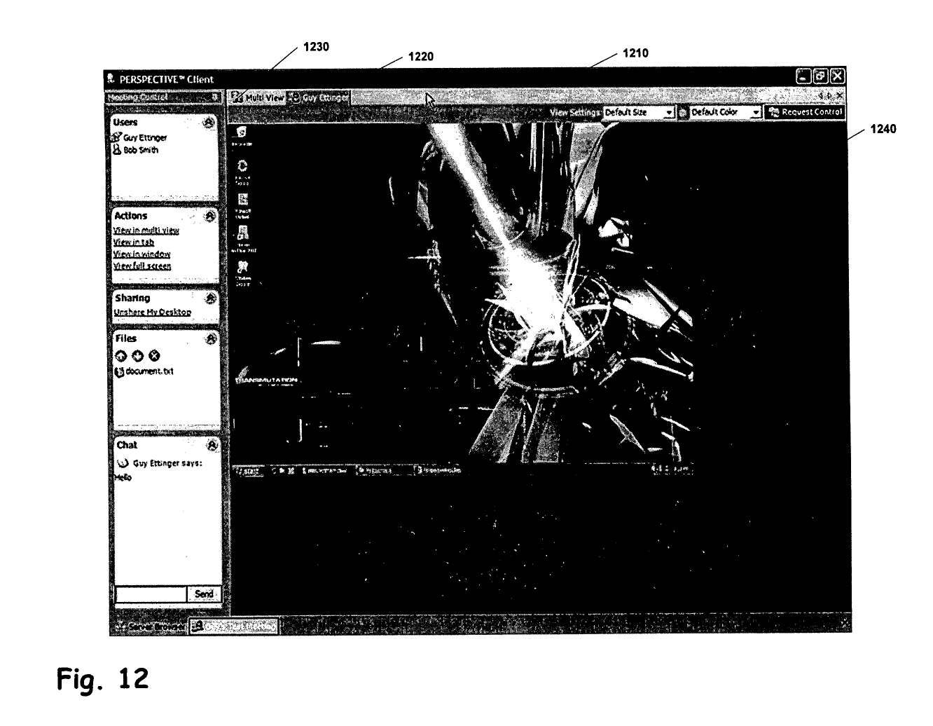

FIG. 12 presents a display image 1200 illustrating a shared computer desktop of a single meeting participant in accordance with an exemplary embodiment of the present invention. Referring to FIG. 12, a window 1210 may include tabs 1220, 1230 that enables a user to move from multiview, which may show images from all of the meeting participants to a view of an image from one participant, such as image 1240. The tab 1220, which provides the single user view, may have the name of the user on the tab 1220, such as the user “Guy Ettinger.”

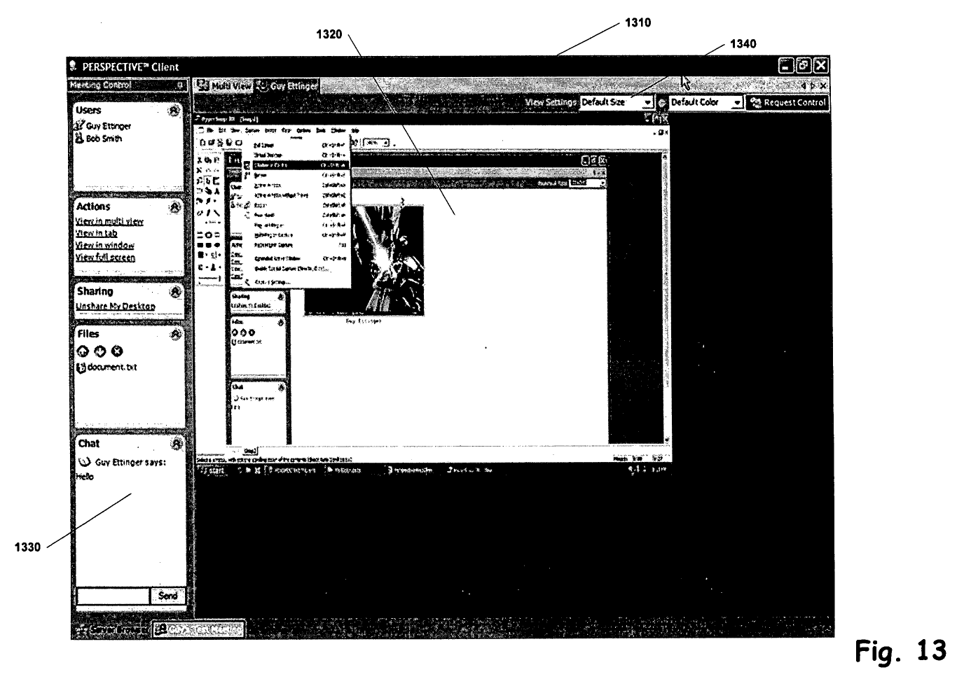

FIG. 13 presents a display image 1300 illustrating a shared computer desktop of a single meeting participant that has been updated in response to a change at the image source in accordance with an exemplary embodiment of the present invention. Referring to FIG. 13, the window 1310 depicts an image from a single user 1320. This image 1320 represents an updated desktop image as compared to the image 1240 presented in FIG. 12. The exemplary embodiment of the present invention provides updates of information from a meeting participant when they have updated information, such as when their desktop image changes. The window 1310 allows the image 1320 to be displayed at a default size, as indicated in the control 1340. The window 1310 also has a section 1330 that displays ongoing chats.

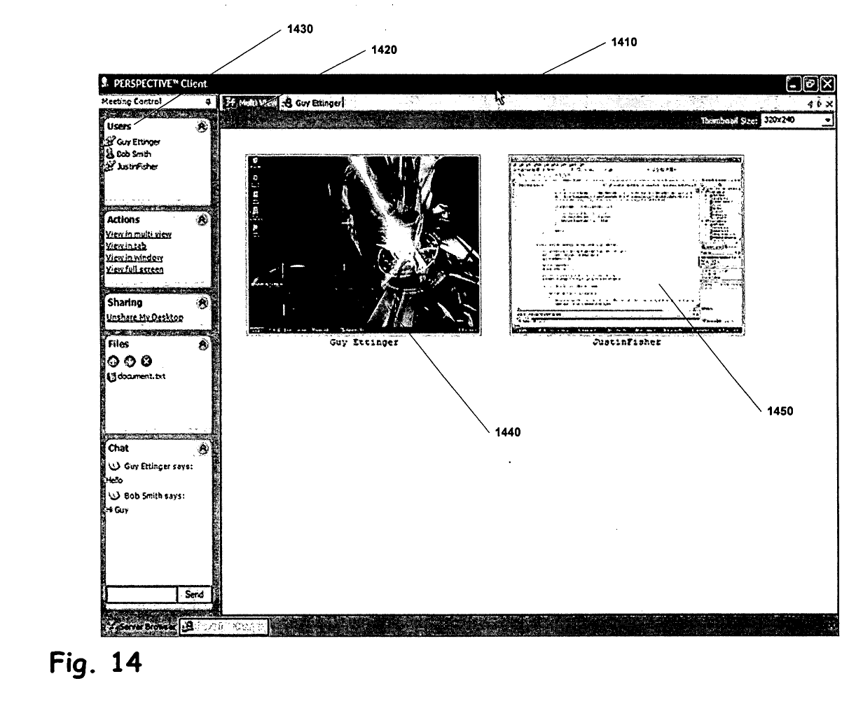

FIG. 14 presents a display image 1400 illustrating multiple shared computer desktops in accordance with an exemplary embodiment of the present invention. Referring to FIG. 14, the window 1410 presents images from the multiview tab 1420. The desktop images 1440, 1450 from two of the meeting participants are shown in the window 1410. The meeting participants, including the two participants whose views are shown, are listed in a section 1430 of the window 1410.

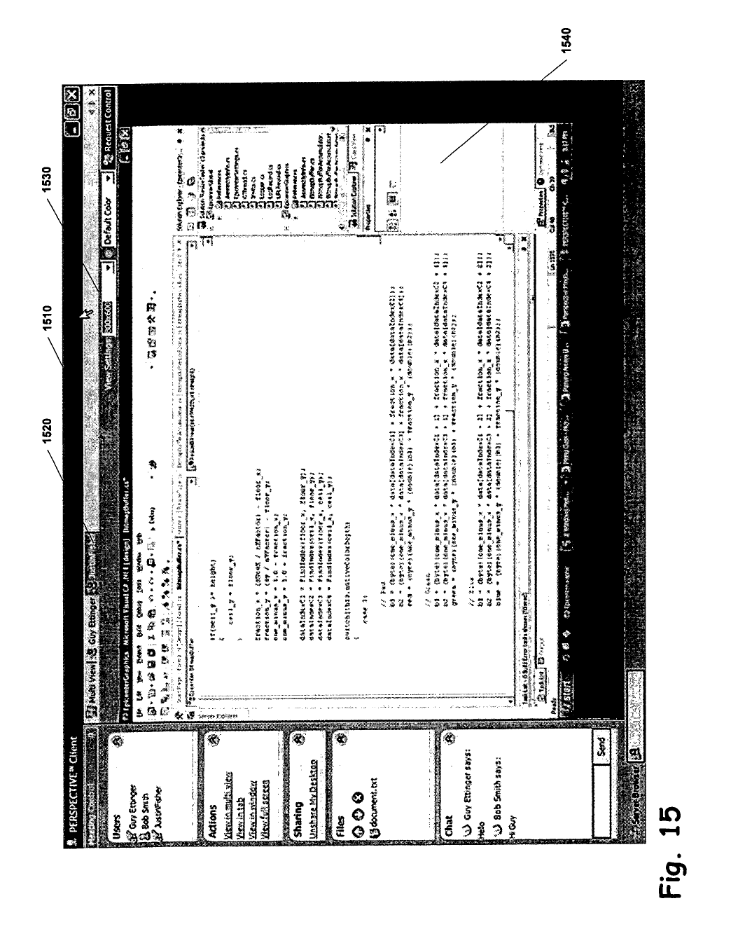

FIG. 15 presents a display image 1500 illustrating a shared computer desktop of one of participants of a meeting in accordance with an exemplary embodiment of the present invention. Referring to FIG. 15, the window 1510 presents a view 1540 from a single meeting participant, by a user selecting a tab 1520 corresponding to a participant. The user may also request a size of the displayed image 1540 different from the default size, such as by changing the setting of a control 1530.

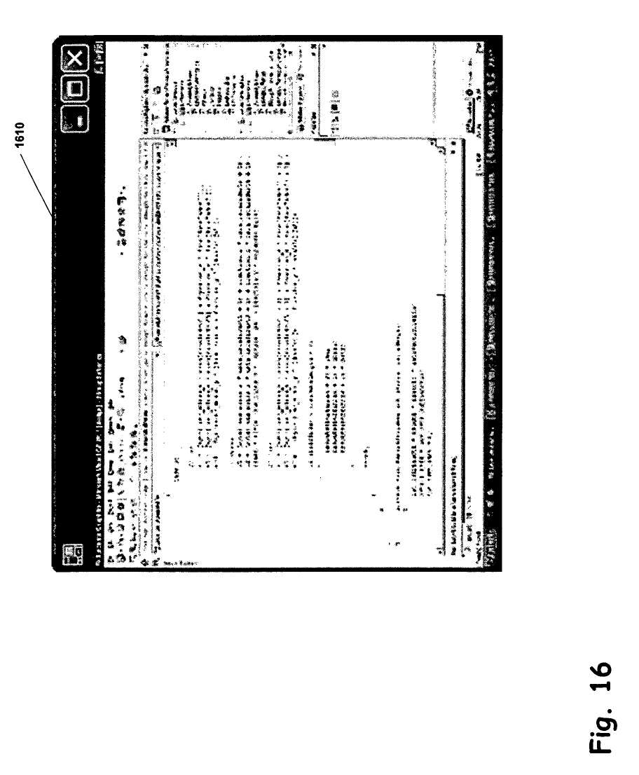

FIG. 16 presents a display image 1600 illustrating a shared computer desktop of one of participants of a meeting that has been detached from a window presenting the meeting in accordance with an exemplary embodiment of the present invention. Referring to FIGS. 2 and 16, a window 1610, corresponding to a view of a desktop of a meeting participant may be detached from the window generated by the adapter module 260. A user may be able to work on information in this window, such as by editing the information. In this way, the meeting participants may collaborate on a product that may be maintained on one of the participant's computers.

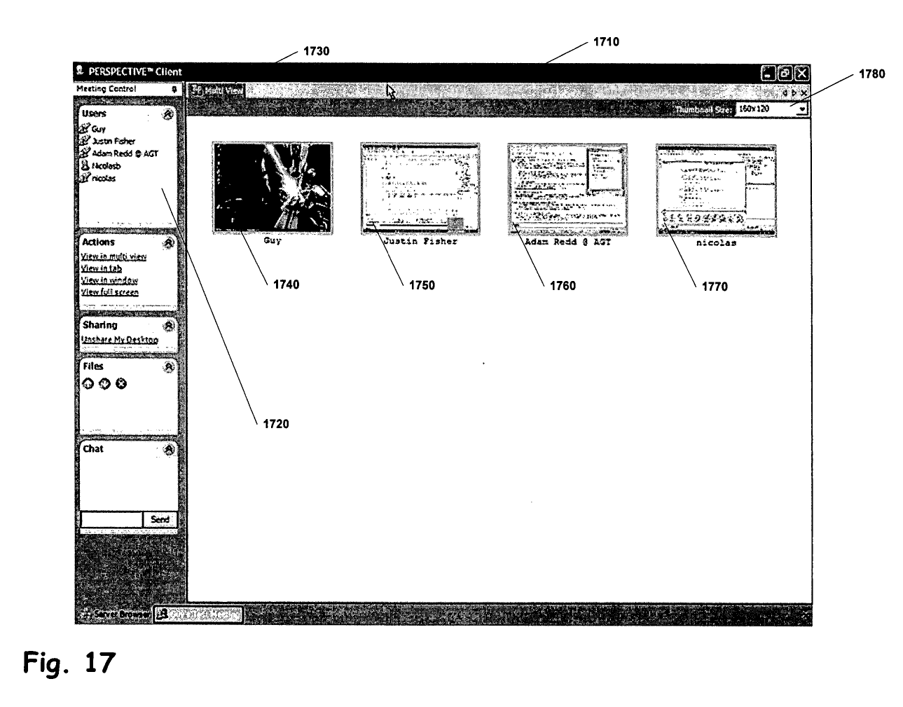

FIG. 17 presents a display image 1700 illustrating sharing computer desktops from multiple meeting resources, with each screen displayed at 160 pixels by 120 pixels, in accordance with an exemplary embodiment of the present invention. Referring to FIG. 17, window 1710 presents a multiview of meeting participants, as listed in a section 1720 of the window 1710. This multiview may be seen by selecting a tab 1730. The views 1740, 1750, 1760, 1770 may correspond to the users' desktop images.

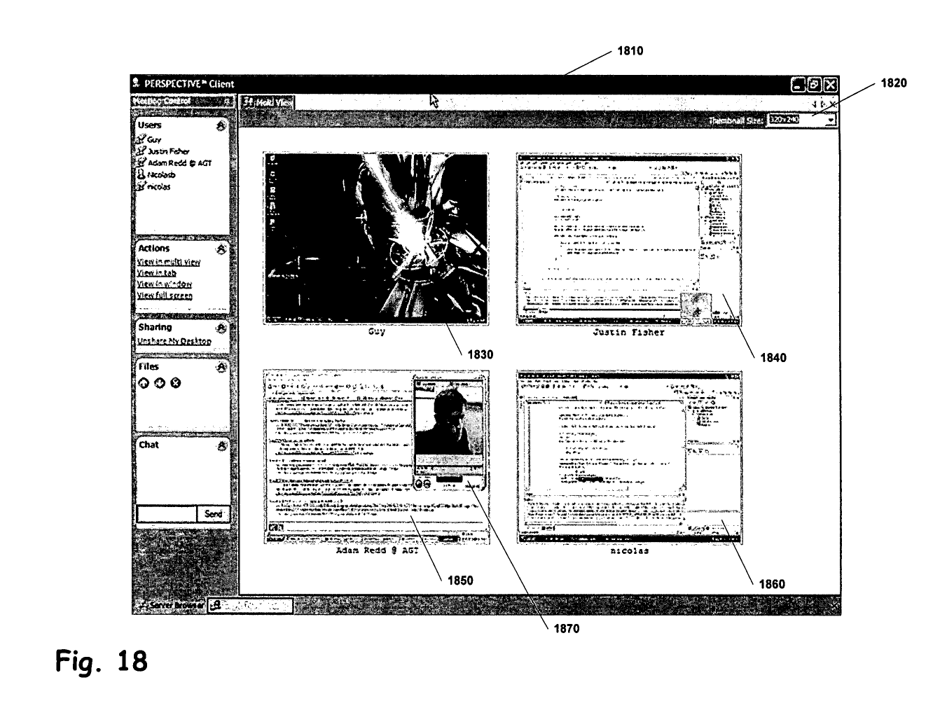

FIG. 18 presents a display image 1800 illustrating sharing computer desktops from multiple meeting resources, with each screen displayed at 320 pixels by 240 pixels, in accordance with an exemplary embodiment of the present invention. Referring to FIGS. 17 and 18, window 1810 presents the same multiview as seen in image 1700. However, the size control 1820 has been used to enlarge the size of the desktop images 1830, 1840, 1850, 1860 (which correspond to the views 1740, 1750, 1760, 1770). A desktop image, such as image 1850, may include a video image 1870, such as one provided by a video camera peripheral to a personal computer.

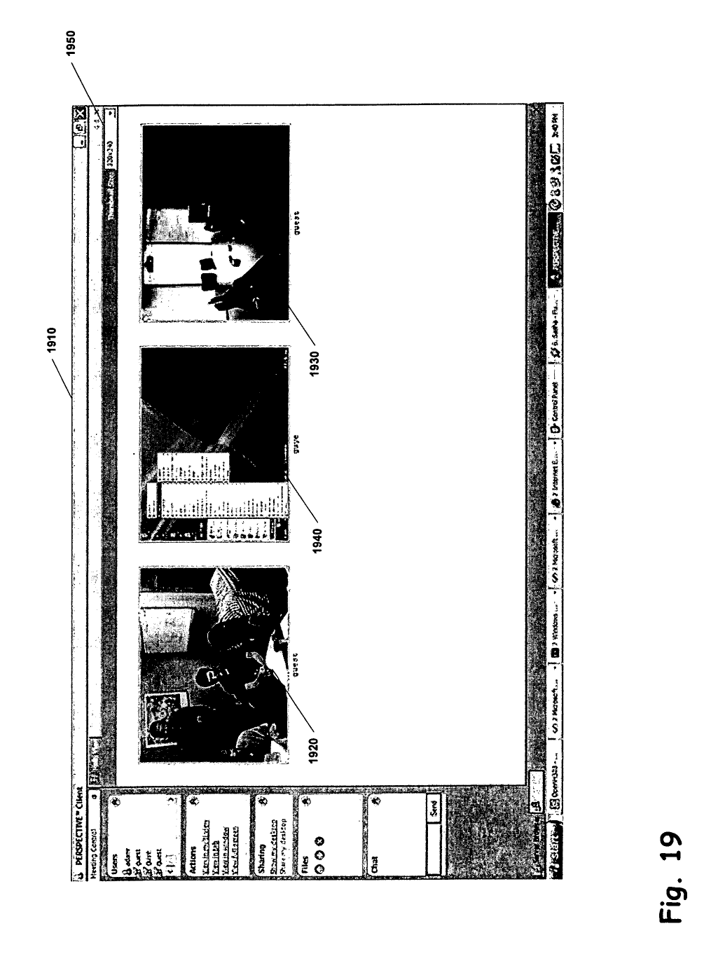

FIG. 19 presents a display image 1900 illustrating sharing computer desktops and video images from multiple meeting resources, with each screen displayed at 320 pixels by 240 pixels, in accordance with an exemplary embodiment of the present invention. Referring to FIG. 19, the window 1910 provides images 1920, 1930, 1940 from meeting participants. These images include images 1920, 1930 from videoconferencing systems. The size of these images, as with the desktop image 1940, is controlled with a control 1950.

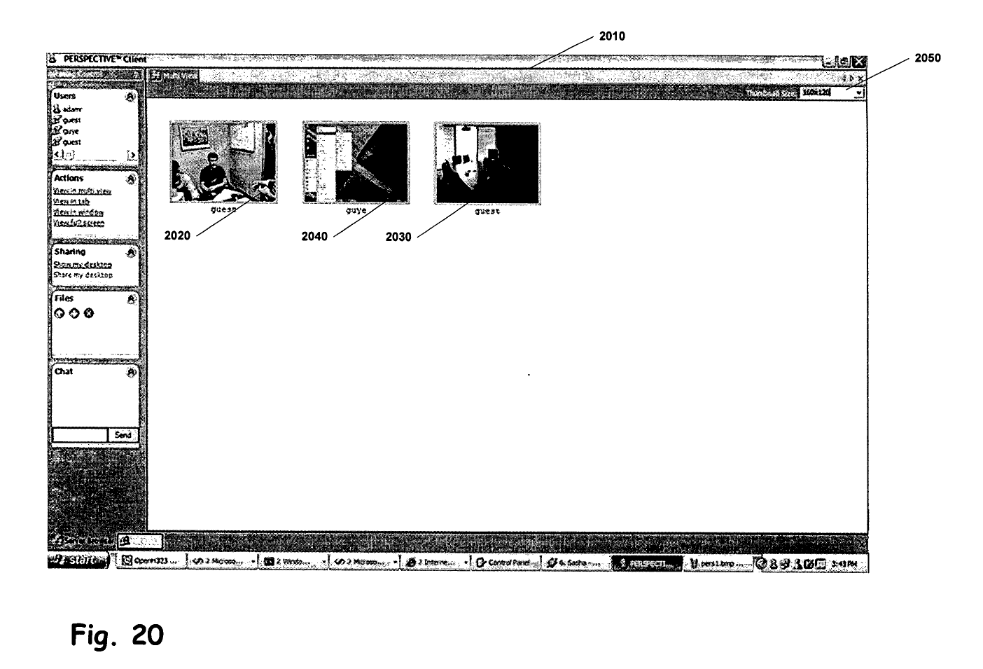

FIG. 20 presents a display image 2000 illustrating sharing computer desktops and video images from multiple meeting resources, with each screen displayed at 160 pixels by 120 pixels, in accordance with an exemplary embodiment of the present invention. Referring to FIGS. 2 and 20, the window 2010 presents display images 2020, 2030, 2040. These images are from the same three meeting participants as shown in FIG. 19. In the image 2000, the control 2050 was used to request from the system server module 210 a smaller sized image.

One skilled in the art would appreciate that the present invention supports a method and system for sharing information between a variety of telecommunication and computing resources. The system may employ client software modules to connect any combination of these resources to one another through a central server. The operation of the system may reduce the demand for bandwidth on a network as compared to other systems by distributing information from a resource only when that information changes.

Although the exemplary embodiments of the present invention described herein are focused on sharing information in a collaborative meeting setting, the present invention can be employed in other settings, such as a system administrator monitoring the performance of components on a computer network or a teacher monitoring the personal computers of students.

What is claimed is:

1. A system for sharing information, comprising:
a first adapter module, associated with a first resource and operable to translate one or more data items from the first resource and further operable to distribute the translated data items in response to a change in one or more of the data items;
a system server module, operable to receive the translated data items from the first adapter module and further operable to process the data items; and
a second adapter module, associated with a second resource and operable to receive the processed data items from the system server module.

2. The system of claim 1 wherein the first resource and the second resource comprise different types of telecommunications and computing systems.

3. The system of claim 2 wherein one of the resources is a personal computer.

4. The system of claim 2 wherein on of the resources is a videoconferencing system.

5. The system of claim 1 wherein the system server module instantiates at least one virtual server to receive, process, and distribute the data items.

6. The system of claim 1 wherein the first and the second adapter modules comprise a resource module and a consumer module.

7. The system of claim 1 wherein the first adapter module is resident on the first resource and the second adapter module is resident on the second resource.

8. The system of claim 1 wherein the first adapter module is not resident on the first resource.

9. A system for sharing information, comprising:
a system server module,
operable to receive one or more input data items from a first adapter module,
further operable to process the received input data items into one or more output data items in response to a request from a resource; and
further operable to distribute the output data items to a second adapter module associated with the resource.

10. The system of claim 9 wherein the system server module instantiates at least one virtual server to receive and process the input data items and distribute the output data items.

11. The system of claim 9 wherein the first adapter module and the second adapter module reside on telecommunications and computing systems.

12. The method of claim 9 wherein the processing of the received data includes resizing an image in response to a request by the resource specifying a maximum image size.

13. A method for sharing information, comprising the steps of:
capturing a first input data instance from a first resource;
translating the first input data instance;
sending the translated first input data instance to a system server module;
capturing a second input data instance;
if the second input data instance is different from the first input data instance, translating the second data instance; and
if the second input data instance is different from the first input data instance, sending the translated second input data instance to the system server module.

14. The method of claim 13 wherein the first resource is a personal computer and the first and second data instances are desktop images.

15. The method of claim 13 wherein the step of translating the first input data instance is responsive to a request from the system server module.

16. The method of claim 13 wherein the step of translating the first input data instance includes resizing an image in response to a request by the system server module specifying a maximum image size.

17. A method for sharing information between a personal computer and a videoconferencing system, comprising the steps of
capturing an input data instance from the videoconferencing system;
translating the input data instance;
sending the translated input data instance to a system server module;
processing the input data instance into an output data instance by the system server module;
distributing the output data instance to an adapter module associated with the personal computer;
translating the output data instance; and
presenting the output data instance by the personal computer.

18. The method of claim 17 wherein the step of translating the input data instance includes sizing a video image to a size specified by the personal computer.

19. The method of claim 17 wherein the adapter module is not resident on the personal computer and the personal computer receives the translated output data instance over a distributed network.

20. A method for sharing information between at least two personal computers, comprising the steps of
capturing an input data instance from a first personal computer;
translating the input data instance;
sending the translated input data instance to a system server module;
processing the input data instance into an output data instance by the system server module;
distributing the output data instance to an adapter module associated with a second personal computer;
translating the output data instance; and
presenting the output data instance by the second personal computer.

21. The method of claim 20 wherein the step of translating the input data instance is responsive to a request by the system server module.

22. The method of claim 20 wherein the input data instance from the first personal computer is a desktop image and the step of translating the input data instance includes sizing the desktop image to a size specified by the second personal computer.

23. A computer-readable storage device storing a set of computer-executable instructions implementing a method for sharing information, comprising the steps of:
capturing a first input data instance from a first resource;
translating the first input data instance;
sending the translated first input data instance to a system server module;
capturing a second input data instance;
if the second input data instance is different from the second input data instance, translating the second data instance; and
if the second input data instance is different from the second input data instance, sending the translated second input data instance to the system server module.

24. The computer-readable storage device of claim 23 wherein the first resource is a personal computer and the first and second data instances are desktop images.

25. The computer-readable storage device of claim 23 wherein the step of translating the first input data instance is responsive to a request from the system server module.

26. The computer-readable storage device of claim 23 wherein the step of translating the first input data instance includes resizing an image in response to a request by the system server module specifying a maximum image size.
